(19) United States
(12) Patent Application Publication
(10) Pub. No.: US 2011/0300518 A1
(43) Pub. Date: Dec. 8, 2011

(54) Nutritional game and method for teaching nutrition to children

(76) Inventor: Sharen Becker, Lutherville, MD (US)

(21) Appl. No.: 13/134,085

(22) Filed: May 27, 2011

Related U.S. Application Data
(60) Provisional application No. 61/352,375, filed on Jun. 7, 2010.

(51) Int. Cl. G09B 19/00; G09B 19/22

(52) U.S. Cl. 434/127; 434/128

(57) ABSTRACT

A nutritional game and related method for educating children regarding proper nutrition is disclosed. The nutritional game includes a board having a character illustrated on the surface of the board which is divided into a plurality of sectors. Nutritional cards are provided in which each nutritional card is configured to cover a respective sector with each nutritional card representing a particular nutrient group, which includes a list of foods representative of that nutrient group. In addition, the nutritional game is played by having the child remove one or more nutritional cards that cover the different sectors of the board as the child eats the foods listed on each nutritional card for a particular nutrient group until all of the nutritional cards are removed from the board, thereby rewarding the child at character illustrated on the board is revealed to the child.

### CROSS-REFERENCE TO RELATED APPLICATIONS

This application claims benefit of U.S. provisional application Ser. No. 61/352,375, entitled “A Beary Balanced Belly”, filed on Jun. 7, 2010.

### FIELD

This document relates to a nutritional game, and in particular to a nutritional game and method for teaching nutrition to children.

### BACKGROUND

It is well known that children require a nutritionally-balanced diet as they grow from infancy into adolescence. As many parents discover, it can be a difficult, if not a trying experience, to persuade children during a meal to eat a proper diet including fruits and vegetables throughout the day. Young children between the ages of 2-6 can be especially resistant to eating a nutritionally-balanced diet. Although there are many nutritional educational games for teaching the concepts of a balanced diet, these games can be too sophisticated for younger children to grasp the concepts related to a nutritionally-balanced diet. As such, there is a need in the art for a nutritional game and method for teaching younger children to eat a nutritionally-balanced diet.

### SUMMARY

In one embodiment, a nutritional game may include a board defining a surface depicting a character, wherein the board is divided in a plurality of sectors. A plurality of cards is associated with the board, wherein each of the plurality of cards depicts a respective nutrient group. In addition, each of the plurality of cards includes a plurality of foods categorized under the respective nutrient group, wherein each of the plurality of cards is configured to cover one of the plurality of sectors when placed on the surface of the board.

A method for nutritional education may include:
providing a board defining a front surface depicting a character, wherein the board is divided in a plurality of sectors;
covering each of the plurality of sectors with a respective one of a plurality of different nutritional cards, each of the plurality of different nutritional cards including indicia representative of a particular nutrient group, wherein each particular nutrient group includes a list of different foods representative of that particular nutrient group; and
removing one or more of the plurality of different nutritional cards as the user eats one or more foods from the list of different foods in the one or more of the plurality of different nutritional cards such that the character depicted on the surface of the board is revealed to an individual as the plurality of different nutritional cards is removed.

Additional objectives, advantages and novel features will be set forth in the description which follows or will become apparent to those skilled in the art upon examination of the drawings and detailed description which follows.

### BRIEF DESCRIPTION OF THE DRAWINGS

FIG. 1 is a front view illustrating a board dividing into a plurality of sectors for a nutritional game;

FIGS. 2A-2F illustrate a plurality of nutritional cards for the nutritional game;

FIG. 3 is a front view illustrating the plurality of nutritional cards positioned on the board of the nutritional game;

FIG. 4 is a front view of the nutritional game illustrating the removal of one of the plurality of nutritional cards from the board according to one method of playing the nutritional game;

FIG. 5 is a front view of the nutritional game illustrating the removal of another one of the plurality of nutritional cards from the board according to the method of playing the nutritional game;

FIG. 6 is a front view of the nutritional game illustrating the removal of all of the plurality of nutritional cards from the board according to the method of playing the nutritional game; and

FIG. 7 is a front view of a reward card for the nutritional game.

Corresponding reference characters indicate corresponding elements thereof among the various views of the drawings. The headings used in the figures should not be interpreted to limit the scope of the claims.

### DETAILED DESCRIPTION

As described herein, a nutritional game and method of playing such a nutritional game to teach children the concepts of a nutritionally-balanced diet is disclosed. In one aspect, the nutritional game includes a board having an illustration of a character, such as a lovable bear character, in which the board is divided into a plurality of sectors configured to be covered by one of a plurality of nutritional cards to begin the game. As the child eats various foods over the course of the day, the child removes one or more of the nutritional cards from the board representing the foods that child has eaten until all of the nutritional cards on the board are removed, thereby exposing the lovable character on the board to the child.

Referring to the drawings, embodiments of the nutritional game are illustrated and generally indicated as 100 in FIGS. 1-6. In general, the nutritional game 100 includes a board 102 that is divided into a plurality of sectors 106 configured to be covered by one of a plurality of nutritional cards 104 when positioned on the front surface 112 of the board 102.

As shown, the board 102 includes a rear surface 110 configured to be affixed to a mounting surface (not shown). The front surface 112 may be illustrated to show a character 105 that covers substantially the entire front surface 112 of the board 102. In addition, the front surface 112 may be divided into a plurality of discrete sectors 106 that divide the character 105 into a number of respective different portions. In one embodiment, the board 102 may be divided into six separate sectors 106, designated 106A-106F, with each sector 106 representing a discrete location on the board 102 for placement of any one of a number of nutritional cards 104. Although the six separate sectors 106 are shown, the board 102 may be divided into any number of sectors 106. The board 102 may be divided into sectors 106 having a square-shaped configuration, an oval-shaped configuration, a circular-shaped configuration, a triangular-shaped configuration, or a combination thereof; however, the configuration of the sectors are not limited in this regard and may have different types of other configurations. The sectors 106 may also have a symmetrically-shaped configuration or an asymmetrically-shaped configuration.

In one embodiment, the board 102 may be a poster or a magnetized board configured to be affixed to a surface (not shown), such as a refrigerator or a wall. In an alternative embodiment, the board 102 may be a substantially solid platform, such as a board made from a paper material, a plastic material, a magnetic material, or cardboard material adapted to be placed upon a surface, such as a table, a kitchen counter, or other flat surface. In some embodiments, the rear surface 110 of the board 102 may include one or more adhesive stickers for securing the board 102 to a surface. In other embodiments, the board 102 may include apertures configured to receive a respective fastening member, such as a pin, nail, or screw for affixing the board 102 to the surface.

As shown, the board 102 includes a character 105 that covers substantially the entire front surface 112. In some embodiments, the character 105 may be a characterization of a toy animal, such as a lovable teddy bear representative of a father bear, a mother bear, a sister bear or a brother bear. In other embodiments, the character 105 may be other characterizations of animals, such as a tiger, a dog, a cat, a lion, a zebra, a horse, an elephant as well as other types of domestic, wild, or fictitious animals. However, the types of characters 105 illustrated on the board 102 in FIG. 3 are not limited in this regard.

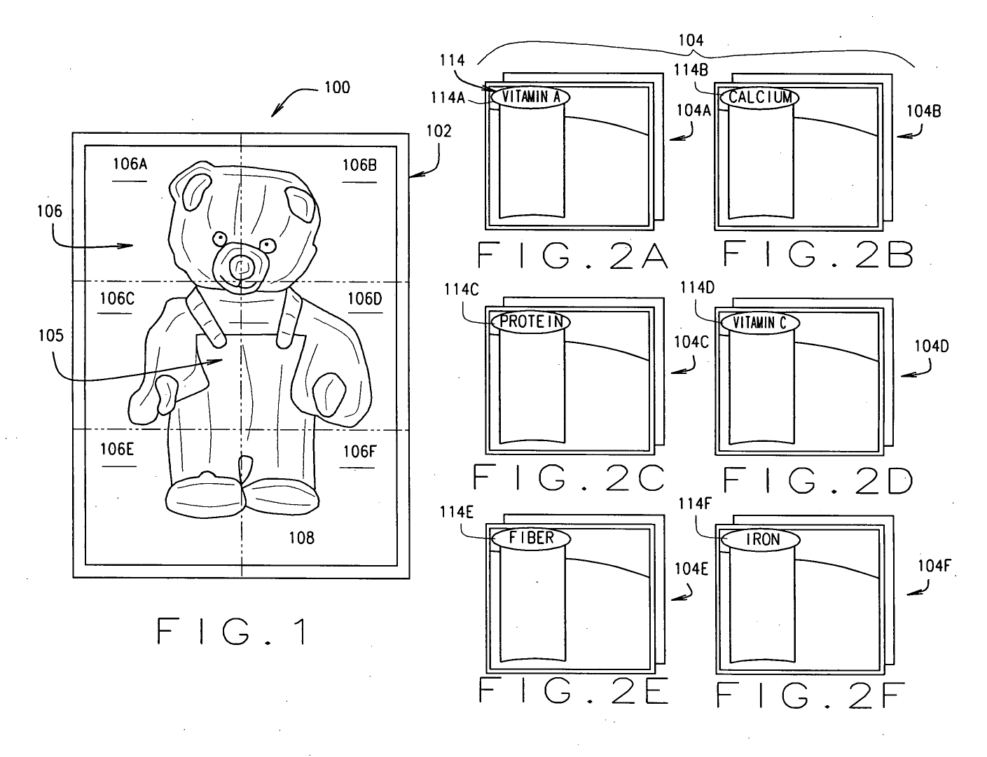

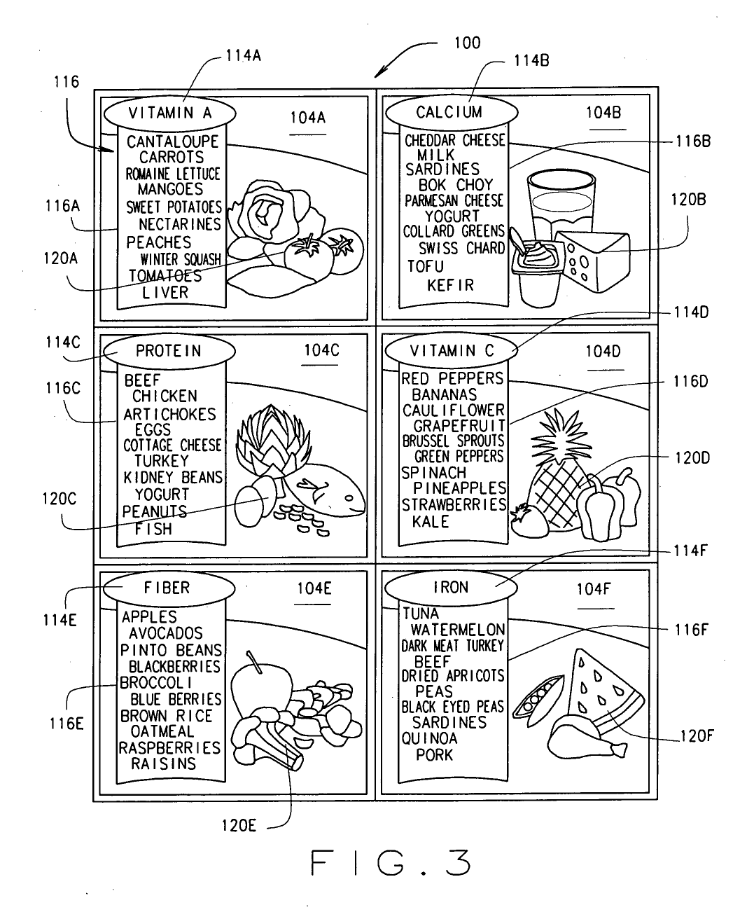

In some embodiments, each of the nutritional cards 104 represents a particular nutrient group 114 containing a plurality of representative foods 116 that a child should consume on a daily basis as part of a nutritional diet and to teach the child the types of foods that form a part of a nutritional diet. As shown in FIGS. 2A-2F, in one embodiment each of the nutritional cards 104 represents a different type nutrient group 114. For example, the nutritional card 104 may include a vitamin A nutrient group 114A, a calcium nutrient group 114B, a protein nutrient group 114C, a vitamin C nutrient group 114D, a fiber nutrient group 114E, or an iron nutrient group 114F. However, the nutrient groups 114 described herein are not limited in this regard and that other types of nutrient groups 114 may be represented. Each of the nutritional cards 104 includes a list of different foods 116 representative of a particular nutrient group 114A-F. In one embodiment, a plurality of nutritional cards, designated 104A, illustrates a list of foods 116 for the vitamin A nutrient group 114A. Similarly, other nutritional cards, designated 104B-F, illustrate a list of foods 116 representative of the calcium nutrient group 114B, protein nutrient group 114C, vitamin C nutrient group 114D, fiber nutrient group 114E, and iron nutrient group 114F, respectively.

As shown in FIG. 3, the list of foods 116 for each of the nutritional cards 104A-F is illustrated. For example, a nutritional card 104A representative of the vitamin A nutrient group 114A may include cantaloupe, carrots, romaine lettuce, mangoes, sweet potatoes, nectarines, peaches, winter squash, tomatoes, and liver. A nutritional card 104B representative of the calcium nutrient group 114B may include a list of foods 116, such as cheddar cheese, milk, sardines, bok choy, parmesan cheese, yogurt, collard greens, swiss chard, tofu, and kefir. A nutritional card 104C representative of the protein nutrient group 114C may include a list of foods 116, such as beef, chicken, artichokes, eggs, cottage cheese, turkey, kidney beans, yogurt, peanuts, and fish. A nutritional card 104D representative of the vitamin C nutrient group 114D may include a list of foods 116, such as red peppers, bananas, cauliflower, grapefruit, brussel sprouts, green peppers, spinach, pineapples, strawberries, and kale. A nutritional card 104E representative of the fiber nutrient group 114E may include a list of foods 116, such as apples, avocados, pinto beans, blackberries, broccoli, blue berries, brown rice, oatmeal, raspberries, and raisins. Finally, a nutritional card 104F representative of the iron nutrient group 114F may include a list of foods 116, such as tuna, watermelon, dark meat turkey, beef, dried apricots, peas, black eyed peas, sardines, quinoa, and pork. However, the list of foods 116 representative of the various nutrient groups 114A-F is not limited in this regard and may include other types of foods 116 that usually fall within a particular nutrient group 114A-F.

Referring to FIGS. 3-7, one method of playing the nutritional game 100 will be discussed. As shown in FIG. 3, the nutritional game 100 is played by setting up the board 102 with the front surface 112 completely covered by nutritional cards 104 arranged such that each sector 106 of the board 102 is substantially covered by a respective nutritional card 104A-F. In some embodiments, the nutritional cards 104 may cover the board 102 by engaging a nutritional card 104 to respective sector 106 such that the nutritional card 104 is secured to the board 102, but allows the child or adult to easily remove the nutritional card from the board 102. For example, an adhesive strip, pin, nail, clip, or tab and slot arrangement may be used to engage the nutritional cards 104 to the board 102. In the tab and slot arrangement (not shown), each sector 106 may define a slot configured to receive a respective tab formed by each nutritional card 104 as the nutritional card 104 is placed to cover a respective sector 106. Conversely, the surface of the board 102 may have an adhesive applied thereto for engaging and disengaging the nutritional card 104 relative to the board 102.

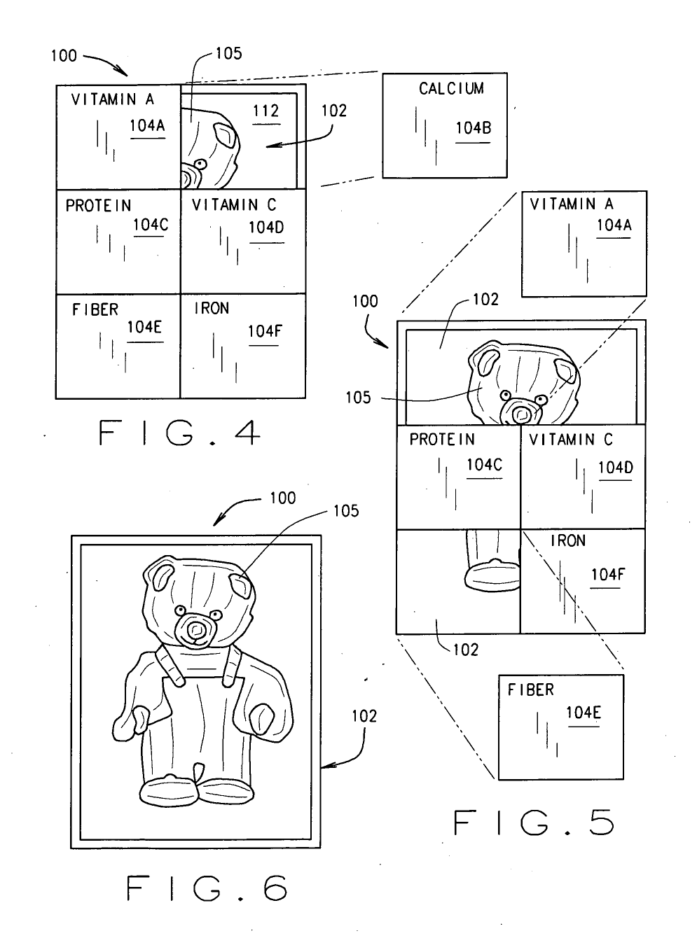

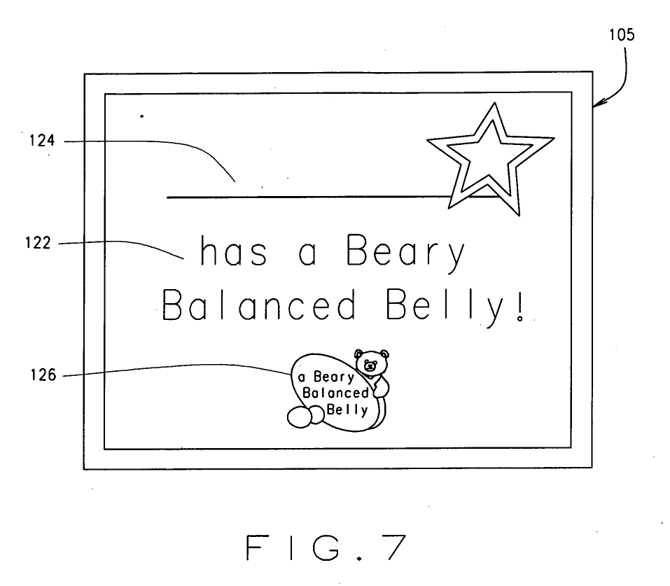

Referring to FIG. 4, an individual, such as the child, family member, teacher, or friend removes one of the nutritional cards 104 listing the foods 116 that the child has eaten over the course of a meal. For example, a child who ate a snack of cheddar cheese would remove nutritional card 1048 from the board 102. As shown in FIG. 5, other nutritional cards 104 are removed as the child eats other foods 116 listed on the nutritional cards 104 remaining on the board 102. For example, nutritional cards 104B and 104E may be removed when the child has eaten one or more foods 116 listed on those nutritional cards 104. The nutritional game 100 continues throughout the day as the child removes the remaining nutritional cards 104 from the board 102 as other foods 116 are eaten during meals until all of the nutritional cards 104 are removed from the board 102. When this occurs, the lovable character 105 illustrated on the front surface 112 of the board 102 may be fully viewed by the child as shown in FIG. 6. Referring to FIG. 7, once all of the nutritional cards 104 are removed from the board 102, a reward card 107 may be provided to the child. In one embodiment, the reward card 107 may include a line 124 configured to permit an individual to write a child's name that is associated with a statement 122, such as “has a Bear Balance Belly”; however, other types of encouraging statements may be written on the reward card 107. In addition, the reward card 107 may include an illustration 126 depicting the lovable character 105 or other types of illustrations 126. The desire of the child to fully view the lovable character 105 and ascertain its identity by sequentially removing the nutritional cards 104 from the board 102 reinforces good eating habits and teaches the child the basic concepts of a nutritionally-balanced diet for the child by eating foods 116 listed on each nutritional card 104 covering the front surface 112 of the board 102.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A nutritional game comprising:
a board defining a surface depicting a character, wherein the board is divided in a plurality of sectors; and
a plurality of cards associated with the board, each of the plurality of cards depicting a respective nutrient group, wherein each of the plurality of cards includes a plurality of foods categorized under the respective nutrient group, wherein each of the plurality of cards is configured to cover one of the plurality of sectors when placed on the surface of the board.

2. The nutritional game of claim 1, wherein the plurality of sectors are at least a rectangular-shape, a circle-shape, a square-shape, a triangular-shape, or an oval-shape.

3. The nutritional game of claim 1, wherein the plurality of nutrient groups comprises at least an iron nutrient group, a fiber nutrient group, a protein nutrient group, a vitamin A nutrient group, a calcium nutrient group, or a vitamin C nutrient group.

4. The nutritional game of claim 1, wherein the vitamin A nutrient group comprises at least cantaloupe, carrots, romaine lettuce, sweet potatoes, peaches, tomatoes, or liver.

5. The nutritional game of claim 1, wherein the fiber nutrient group comprises at least apples, avocadoes, pinto beans, blackberries, brown rice, oatmeal, raspberries, or raisins.

6. The nutritional game of claim 1, wherein the protein nutrient group comprises at least beef, chicken, artichokes, eggs, cottage cheese, turkey, kidney beans, peanuts, and fish.

7. The nutritional game of claim 1, wherein the iron nutrient group comprises at least tuna, watermelon, dark meat turkey, beef, dried apricots, peas, black eyed peas, sardines, quinoa, or pork.

8. The nutritional game of claim 1, wherein the calcium nutrient group comprises at least cheddar cheese, milk, sardines, bok choy, parmesan cheese, yogurt, collard greens, tofu, or kefir.

9. The nutritional game of claim 1, wherein the vitamin C nutrient group comprises at least red peppers, bananas, cauliflower, bananas, brussel sprouts, green peppers, spinach, pineapples, strawberries, or kale.

10. The nutritional game of claim 1, wherein the character comprises a domestic animal, a wild animal, or a fictitious animal.

11. The nutritional game of claim 10, wherein the character comprises a bear character.

12. The nutritional game of game 11, wherein the bear character comprises a father bear character, a mother bear character, a brother bear character, a sister bear character, or a baby bear character.

13. A method for nutritional education comprising:
providing a board defining a front surface depicting a character, wherein the board is divided in a plurality of sectors;
covering each of the plurality of sectors with a respective one of a plurality of different nutritional cards, each of the plurality of different nutritional cards including indicia representative of a particular nutrient group, wherein each particular nutrient group includes a list of different foods representative of that particular nutrient group; and
removing one or more of the plurality of different nutritional cards as the user eats one or more foods from the list of different foods in the one or more of the plurality of different nutritional cards such that the character depicted on the surface of the board is revealed to an individual as the plurality of different nutritional cards is removed.

14. The method of claim 13, wherein the particular nutrient group comprises at least an iron nutrient group, a fiber nutrient group, a protein nutrient group, a vitamin A nutrient group, a calcium nutrient group, or a vitamin C nutrient group.

15. The method of claim 13, further comprising:
removing the plurality of nutritional cards until no further nutritional cards are covering the plurality of sectors.

16. The method of claim 15, wherein the plurality of nutritional cards are removed from the board one at a time.

17. The method of claim 15, wherein the plurality of nutritional cards are removed until no nutritional cards are left on the board, wherein a reward card is provided to a user when all of the nutritional cards are removed.

18. The method of claim 13, wherein covering each of the plurality of sectors with a respective one of the plurality of different nutritional cards includes engaging the respective one of the plurality of different nutritional cards to the board.

19. The method of claim 18, wherein engaging the respective one of the plurality of different nutritional cards to the board comprises attaching the respective one of the plurality of different nutritional cards using at least an adhesive, a pin, a nail, a clip, or a slot and tab arrangement.

20. The method of claim 18, wherein engaging the respective one of the plurality of different nutritional cards to the board comprises using an adhesive on the surface of the board to engage the respective one of the plurality of different nutritional cards.
